(19) United States
(12) Patent Application Publication
(10) Pub. No.: US 2008/0291150 A1
(43) Pub. Date: Nov. 27, 2008

(54) Thermal Compensation Device for Display Device

(76) Inventors: Jen-Ta Yang, Hsinchu County (TW); Chih-Hsuan Lin, Hualien County (TW)

Correspondence Address: NORTH AMERICA INTELLECTUAL PROPERTY CORPORATION, P.O. BOX 506, MERRIFIELD, VA, 22116, US

(21) Appl. No.: 11/781,269

(22) Filed: Jul. 22, 2007

(30) Foreign Application Priority Data
May 23, 2007 (TW) 096118368

(51) Int. Cl. G09G 3/36

(52) U.S. Cl. 345/101

(57) ABSTRACT

In order to solve a problem of deviation of a gamma curve of a display device due to temperature variation, the present invention provides a thermal compensation device for compensating a gamma curve of a display device. The thermal compensation device includes a thermal sensor, a storage unit, and a thermal compensation unit. The thermal sensor is used for detecting an ambient temperature inside the display device. The storage unit is used for storing a plurality of numerical data groups. The thermal compensation unit is coupled to the thermal sensor and the storage unit is used for selecting one numerical data group from the plurality of numerical data groups and transforming original image data into compensated image data with the selected numerical data group.

### BACKGROUND OF THE INVENTION

1. Field of the Invention

The present invention relates to a circuit device for a display device, and more particularly, to a thermal compensation device for compensating a gamma curve of a display device according to an ambient temperature.

2. Description of the Prior Art

A liquid crystal display device (LCD) has characteristics of light shape, low power consumption, zero radiation, etc, and has been widely used in many information technology (IT) products, such as notebooks and personal digital assistants (PDA). Operations of the LCD start from transforming external video signals into digital signals for performing image processing, such as gamma correction, image scaling, color difference adjustment, etc. Then, the digital signals are transformed into analog signals and sent to a panel for driving liquid crystal molecules. Taking gamma correction for example, a gamma curve characteristic of a panel of an LCD is generally measured before the LCD leaves a factory, for convenience of design of a driving circuit in the LCD.

Please refer to FIG. 1. FIG. 1 illustrates a schematic diagram of a prior art display device 10. The display device 10 comprises a timing controller 12, a source driver 14, and a panel 16. The operational principle is as follows. The timing controller 12 generates timing signals for controlling the source driver 14, and performs simple image processing operations for original digital image data SDATA1, so as to output digital image data SDATA2 to the source driver 14. A digital-to-analog converter (DAC) 18 of the source driver 14 transforms the digital image data SDATA2 into voltage signals VDATA according to reference voltages V1˜Vn−1, and outputs the voltage signals VDATA to the panel 16 for controlling light penetration of liquid crystal molecules. In general, before the panel 16 leaves a factory, the brightness of the panel 16 at different gray levels are measured. Then, the relation between the brightness and the gray levels is represented by a curve, named a gamma curve. In order to avoid output image distortion, the display device 10 performs gamma correction by setting values of resistors R1˜Rn during the transformation procedure of the digital image data. The resistors R1˜Rn produces the reference voltages V1˜Vn−1 after voltage division, and accordingly, the DAC converter 18 can produce the voltage signal VDATA corresponding to the gamma curve of the panel 16.

However, the measuring procedure of the panel 16 does not consider temperature requirements. That is, the gamma curve only conforms to a limited range of temperatures. If an ambient temperature changes dramatically (e.g. season change), characteristics of the resistors R1˜Rn change correspondingly, causing misalignment of the dividing voltages (the references voltages V1˜Vn−1). Moreover, the penetration ability of the liquid crystal molecules also changes as the temperature changes, and thus, affects the quantity of lights penetrating the liquid crystal molecules. As a result, brightness of the grey levels to be displayed is different from expectation, resulting in image distortion. Therefore, the prior art display device 10 is not suitable for an environment having dramatic temperature variation.

### SUMMARY OF THE INVENTION

It is therefore a primary objective of a thermal compensation device for a display device for solving an image distortion problem resulted from deviation of a gamma curve of a display device due to temperature variation.

The present invention discloses a thermal compensation device for a display device for compensating a gamma curve of the display device. The thermal compensation device comprises a thermal sensor, a storage unit, and a thermal compensation unit. The thermal sensor is for detecting an ambient temperature inside the display device. The storage unit is for storing a plurality of numerical data groups. The thermal compensation unit is coupled to the thermal sensor and the storage unit is for selecting one numerical data group from the plurality of numerical data groups according to the ambient temperature detected by the thermal sensor and transforming an original image data into a compensated image data with the selected numerical data group.

The present invention further discloses a thermal compensation method for compensating a gamma curve of a display device. The thermal compensation method comprises storing a plurality of numerical data groups in a storage unit of the display device, detecting an ambient temperature inside the display device, selecting one numerical data group from the plurality of numerical data groups according to the ambient temperature detected by the thermal sensor, and transforming an original image data into a compensated image data with the selected numerical data group.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior art display device.

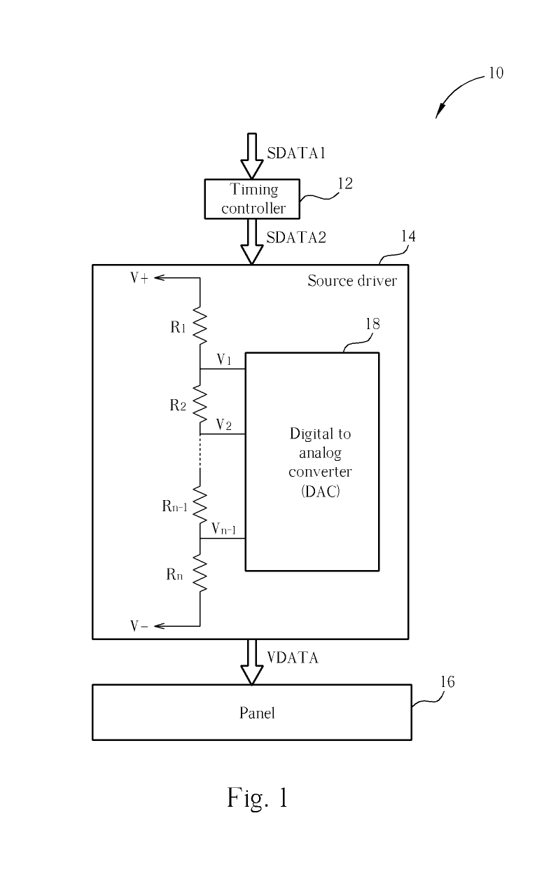

FIG. 2 illustrates a schematic diagram of a display device according to an embodiment of the present invention.

FIG. 3 illustrates a schematic diagram of a thermal compensation device according to FIG. 2.

FIG. 4 illustrates a schematic diagram of gamma curves of a panel with different temperatures of a display device according to FIG. 2.

FIG. 5 illustrates a schematic diagram of a compensation operational principle of a thermal compensation unit shown in FIG. 3.

FIG. 6 illustrates a flow chart of a thermal compensation procedure according to an embodiment of the present invention.

### DETAILED DESCRIPTION

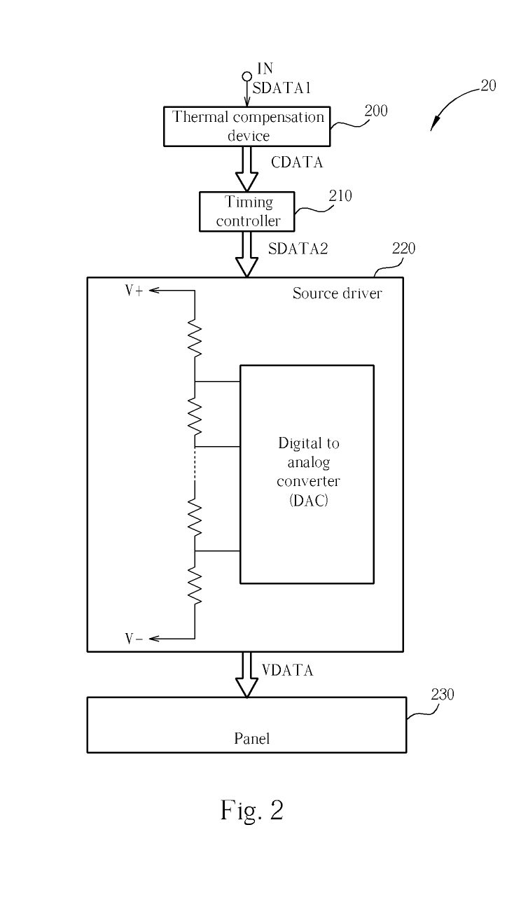

Please refer to FIG. 2. FIG. 2 illustrates a schematic diagram of a display device 20 according to an embodiment of the present invention. The display device 20 can processes image data for compensating the displayed gamma characteristics according to temperature variation. The display device 20 comprises a reception end IN, a thermal compensation device 200, a timing controller 210, a source driver 220, and a panel 230. Structures and operational principles of the timing controller 210, the source driver 220, and the panel 230 are the same as those of the timing controller 12, the source driver 14,and the panel 16, which will not be narrated in detail. The thermal compensation device 200 can be installed in front of the timing controller 210, so as to process original image data SDATA1 for the timing controller 210. Also, the thermal compensation device 200 can be installed between the timing controller 210 and the source driver 220, so as to process digital image data SDATA2 provided by the timing controller 210 for the source driver 220. For clarity, in FIG. 2, the thermal compensation device 200 is installed in front of the timing controller 210 for compensating the original digital image data SDATA1 received by the reception end IN, which usually comprises red, green, and blue image data.

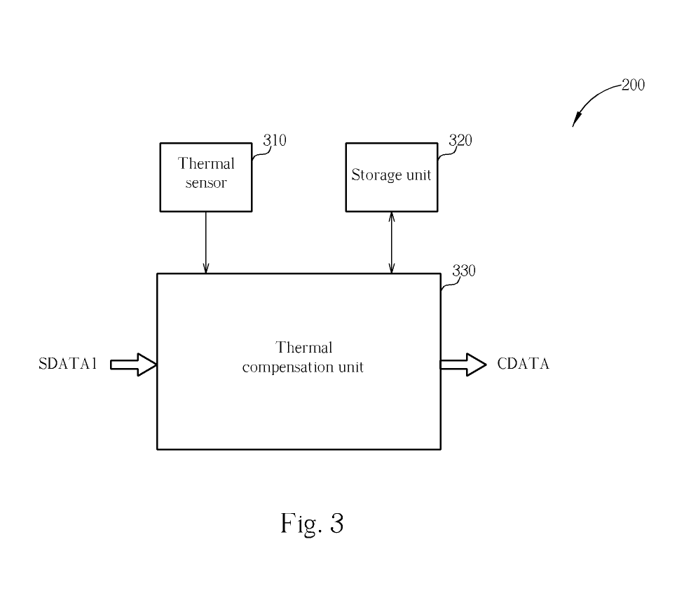

Please refer to FIG. 3. FIG. 3 illustrates a schematic diagram of the thermal compensation device 200 shown in FIG. 2. The thermal compensation device 200 is utilized for compensating a gamma curve of the display device 20, and comprises a thermal sensor 310, a storage unit 320, and a thermal compensation unit 330. The thermal sensor 310 is utilized for detecting an ambient temperature inside the display device 20. The storage unit 320 is utilized for storing a plurality of numerical data groups. The thermal compensation unit 330 is coupled to the thermal sensor 310 and the storage unit 320, and utilized for selecting one numerical data group from the plurality of numerical data groups according to the ambient temperature detected by the thermal sensor 310. Then, according to an equation, the thermal compensation unit 330 transforms the original image data SDATA1 into compensated image data CDATA through the selected numerical data group. The relation between input and output of the equation is as follows

$$[ \begin{matrix}{R}^{′} \\ {G}^{′} \\ {B}^{′}\end{matrix} ] = [ \begin{matrix}R 1 & G 1 & B 1 \\ R 2 & G 2 & B 2 \\ R 3 & G 3 & B 3\end{matrix} ] [ \begin{matrix}R \\ G \\ B\end{matrix} ] + [ \begin{matrix}rc \\ gc \\ bc\end{matrix} ] \qquad ( 1 )$$

where

$$[ \begin{matrix}R \\ G \\ B\end{matrix} ]$$

is the original image data SDATA1,

$$[ \begin{matrix}{R}^{′} \\ {G}^{′} \\ {B}^{′}\end{matrix} ]$$

is the compensated image data CDATA, and

$$[ \begin{matrix}R 1 & G 1 & B 1 \\ R 2 & G 2 & B 2 \\ R 3 & G 3 & B 3\end{matrix} ] and [ \begin{matrix}rc \\ gc \\ bc\end{matrix} ]$$

are numerical data selected from the storage unit 320.

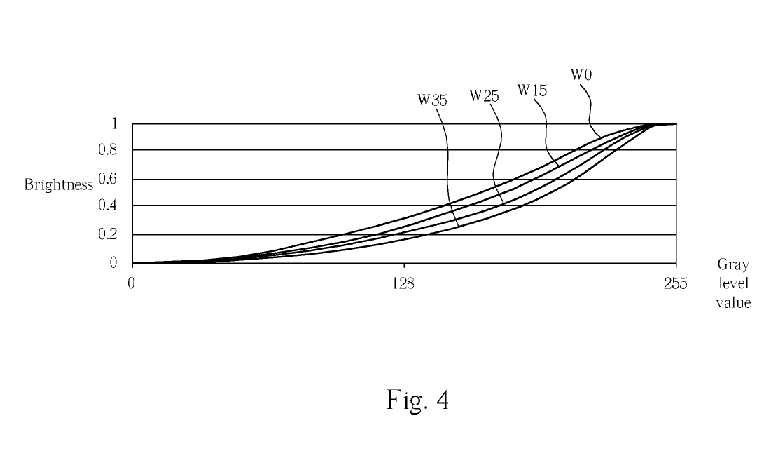

The numerical data groups stored in the storage unit 320 can be obtained through the following ways. First, gamma curves with different gamma values are obtained under different temperatures by practically measuring a panel of the display device 20. Please refer to FIG. 4. FIG. 4 illustrates a schematic diagram of gamma curves W1, W15, W25, and W35 of the panel of the display device 20 under different temperatures. A horizontal axis represents gray level values 0˜255, while a vertical axis is normalized brightness values between 0 and 1. Gamma values of the gamma curves W0, W15, W25, and W35 corresponding to ambient temperatures 0, 15, 25, and 35° C. are 1.96, 2.11, 2.20, and 2.30. Suppose the panel 230 of the display device 20 works with the gamma curves W25 when leaving the factory. Then, the numerical data groups can be calculated according to relations between different curves, that is, W0 and W25, W15 and W25, and W35 and W25. Briefly speaking, each non-predefined numerical data can be obtained from FIG. 4.

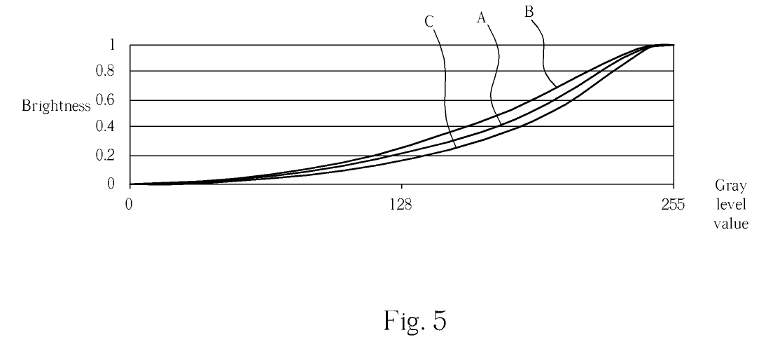

Please refer to FIG. 5. FIG. 5 illustrates a schematic diagram of the operational principle of the thermal compensation unit 230 shown in FIG. 3. FIG. 5 is similar to FIG. 4, and illustrates gamma curves A, B, and C. The gamma curve A is a predefined operational curve of the panel 230 of the display device 20 when leaving a factory, like the gamma curve W25 shown in FIG. 4. Suppose the gamma curve of the panel moves from the gamma curve A to the gamma curve C (e.g. from the gamma curve W25 to W35) due to ambient temperature variation. After the display device 20 is tuned on, the thermal sensor 310 detects an ambient temperature corresponding to the gamma curve C. Then, the thermal compensation unit 330 selects one numerical data group (e.g.

$$[ \begin{matrix}R 1 & G 1 & B 1 \\ R 2 & G 2 & B 2 \\ R 3 & G 3 & B 3\end{matrix} ] and [ \begin{matrix}rc \\ gc \\ bc\end{matrix} ]$$

), which is generated according to the relation between the gamma curves A and B (e.g. W15 and W25), from the storage unit 320 according to the detected result. Using the equation (1), the compensation image data CDATA is corresponding to gamma curve B, meaning that the equation (1) transforms the original image data with characteristics of the gamma curve A into image data with characteristics of the gamma curve B. Therefore, since characteristic of the panel is the gamma curve C, when the compensation data CDATA is outputted to the penal, display characteristics of the panel returns to the gamma curve A. As a result, the original display effect is achieved and avoided from influences of temperature variation.

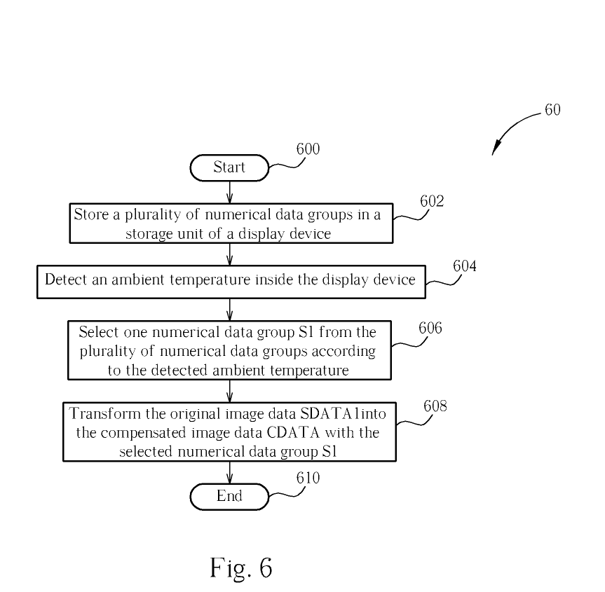

Please refer to FIG. 6. FIG. 6 illustrates a flow chart of a thermal compensation procedure 60 according to an embodiment of the present invention. The thermal compensation procedure 60 is used for compensating gamma curves of the panel 230 of the display device 20 according to the thermal compensation device 200, and comprises following steps:

Step 600: Start.

Step 602: Store a plurality of numerical data groups in the storage unit 230 of the display device 20.

Step 604: Detect an ambient temperature inside the display device 20.

Step 606: Select a numerical data group S1 from the plurality of numerical data groups according to the detected ambient temperature.

Step 608: Transform the original image data SDATA1 into the compensated image data CDATA with the selected numerical data group S1.

Step 610: End.

According to the procedure 60, the present invention adjusts output image data according to the ambient temperature inside the display device for avoiding losing original gamma characteristics when displaying image. Suppose the storage unit 230 of the display device 20 stores gamma curves D, E, and F with gamma values ┌1, ┌2, and ┌3 (┌1>┌2>┌3), and the gamma curve E is the gamma curve set when leaving a factory. If a gamma curve of the panel moves to the gamma curve F because of temperature variation, a numerical data S1 is selected by thermal detection as the matrices

$$[ \begin{matrix}R 1 & G 1 & B 1 \\ R 2 & G 2 & B 2 \\ R 3 & G 3 & B 3\end{matrix} ] and [ \begin{matrix}rc \\ gc \\ bc\end{matrix} ]$$

of the equation (1). Using the equation (1), the original digital image data SDATA1 is transformed into the compensation image data CDATA, to make gamma characteristics of the compensation image data CDATA corresponding to the gamma curve D. That is, if the gamma curve of the panel shifts to a gamma curve (the gamma curve F) with a lower gamma value (┌3), then the image data SDATA1 is transformed to be corresponding to a gamma curve (the gamma curve D) with a higher gamma value (┌1), and vice versa. If the gamma curve of the panel shifts to a gamma curve (the gamma curve D) with a higher gamma value (┌1), then the image data SDATA1 is transformed to be corresponding to a gamma curve (the gamma curve F) with a lower gamma value (┌3). Therefore, the panel can maintain the gamma characteristic as the display characteristics set when leaving a factory, and avoid image distortion caused by temperature variation.

In conclusion, the thermal compensation device of the present invention compensates digital image data according to an ambient temperature for compensating defects such as misalignment of reference voltages, penetration variation of liquid crystal molecules, etc, so as to maintain original display characteristics of the panel and avoid influences of temperature variation. Therefore, the thermal compensation device of the present invention makes the display device suitable for an environment with dramatic temperature variation.

Those skilled in the art will readily observe that numerous modifications and alterations of the device and method may be made while retaining the teachings of the invention.

What is claimed is:

1. A thermal compensation device for compensating a gamma curve of a display device comprising:
a thermal sensor for detecting an ambient temperature inside the display device;
a storage unit for storing a plurality of numerical data groups; and
a thermal compensation unit coupled to the thermal sensor and the storage unit, for selecting one numerical data group from the plurality of numerical data groups according to the ambient temperature detected by the thermal sensor, and transforming an original image data into a compensated image data with the selected numerical data group.

2. The thermal compensation device of claim 1, wherein the thermal compensation unit transforms the original image data into the compensated image data with the selected numerical data group according to an equation.

3. The thermal compensation device of claim 2, wherein the equation is A=(B·C)+D;
the matrix A represents the compensated image data, the matrix C represents the original image data, and the matrix B and the matrix D represent selected numerical data groups.

4. A thermal compensation method for compensating a gamma curve of a display device comprising:
storing a plurality of numerical data groups in a storage unit of the display device;
detecting an ambient temperature inside the display device;
selecting one numerical data group from the plurality of numerical data groups according to the detected ambient temperature; and
transforming an original image data into a compensated image data with the selected numerical data group.

5. The thermal compensation device of claim 4, wherein transforming the original image data into the compensated image data with the selected numerical data group is transforming the original image data into the compensated image data with the selected numerical data group according to an equation.

6. The thermal compensation device of claim 5, wherein the equation is A=(B·C)+D;
the matrix A represents the compensated image data, the matrix C represents the original image data, and the matrix B and the matrix D represent selected numerical data groups.

7. A display device capable of compensating a gamma curve according to temperature variation comprising:
a reception end for receiving video signal;
a timing controller for performing image processing operations for received data, for generating a first image data;
a source driver for performing image processing operations for received data, for generating a voltage signal;
a panel coupled to the source driver, for receiving the voltage signal for displaying images; and
a thermal compensation device for compensating a gamma curve comprising:
a thermal sensor for detecting an ambient temperature inside the display device;
a storage unit for storing a plurality of numerical data groups; and
a thermal compensation unit coupled to the thermal sensor and the storage unit, for selecting one numerical data group from the plurality of numerical data groups according to the ambient temperature detected by the thermal sensor, and transforming an original image data into a compensated image data with the selected numerical data group.

8. The display device of claim 7, wherein the thermal compensation device is coupled between the reception end and the timing controller.

9. The display device of claim 7, wherein the thermal compensation device is coupled between the timing controller and the source driver.

10. The display device of claim 7, wherein the thermal compensation unit transforms the original image data into the compensated image data with the selected numerical data group according to an equation.

11. The display device of claim 10, wherein the equation is A=(B·C)+D;
A represents the compensated image data, the matrix C represents the original image data, and the matrix B and the matrix D represent selected numerical data groups.
